(19) United States
(12) Patent Application Publication
(10) Pub. No.: US 2013/0149452 A1
(43) Pub. Date: Jun. 13, 2013

(54) FOAMS AND ARTICLES MADE FROM FOAMS CONTAINING 1-CHLORO-3,3,3-TRIFLUOROPROPENE (1233ZD)

(71) Applicant: Honeywell International, Inc., Morristown, NJ (US)

(72) Inventors: Mary C. BOGDAN, Buffalo, NY (US); David J. WILLIAMS, East Amherst, NY (US); Yiu Keung LING, Amherst, NY (US)

(73) Assignee: Honeywell International, Inc., Morristown, NJ (US)

(21) Appl. No.: 13/710,416

(22) Filed: Dec. 10, 2012

Related U.S. Application Data
(60) Provisional application No. 61/569,061, filed on Dec. 9, 2011.

(51) Int. Cl. C08J 9/00

(52) U.S. Cl. CPC C08J 9/00
USPC 427/373

(57) ABSTRACT

The present invention relates to polyurethane foams having a polymeric foam structure including a plurality of closed cells therein; and an HFO or HCFO blowing agent, including HCFO-1233zd. In certain aspects, the present invention relates to foam premixes, and the resulting foam structures, that include HCFO-1233zd as blowing agent used alone, or in certain aspects, in a blend with a co-blowing agent such as cyclopentane, iso-pentane, n-pentane, or methyl formate.

### CROSS REFERENCES TO RELATED APPLICATIONS

The present application claims priority to U.S. Provisional application Ser. No. 61/569,061, filed on Dec. 9, 2011, the contents of which is incorporated herein by reference in its entirety.

This application is also a continuation-in-part of U.S. patent application Ser. No. 13/191,070, filed on Jul. 26, 2011, which is a continuation-in-part of U.S. patent application Ser. No. 12/847,381, filed on Jul. 30, 2010, which claims the benefit of U.S. Provisional patent application Ser. No. 61/232,836, filed Aug. 11, 2009, the contents each of which are incorporated herein by reference in their entirety.

This application is also a continuation-in-part of U.S. patent application Ser. No. 12/276,137, filed Nov. 21, 2008, which claims priority to U.S. Provisional patent application No. 60/989,977 filed Nov. 25, 2007, and also claims priority to PCT patent application number PCT/US07/64570 filed Mar. 21, 2007 which claims priority to U.S. patent application Ser. No. 11/474,887 filed Jun. 26, 2006 and which claims priority to U.S. Provisional patent application Ser. No. 60/784,731 filed Mar. 21, 2006, each of which is incorporated herein by reference in their entirety.

### FIELD OF THE INVENTION

The present invention pertains to foams and to articles made from foams and methods for the preparation thereof, and in particular to polyurethane and polyisocyanurate foams and methods for the preparation and uses thereof.

### BACKGROUND OF THE INVENTION

The class of foams known as low density, rigid to semi-rigid polyurethane or polyisocyanurate foams has utility in a wide variety of insulation applications, including roofing systems, building panels, building envelope insulation, spray applied foams, one and two component froth foams, insulation for refrigerators and freezers, and so called integral skin foam for cushioning and safety application such as steering wheels and other automotive or aerospace cabin parts, shoe soles, amusement park restraints, and the like. An important factor in the large-scale commercial success of many rigid to semi-rigid polyurethane foams has been the ability of such foams to provide a good balance of properties. In general, rigid polyurethane and polyisocyanurate foams should provide outstanding thermal insulation, excellent fire resistance properties, and superior structural properties at reasonably low densities.

As is known, blowing agents are used to form the cellular structure required for such foams. It has been common to use liquid fluorocarbon blowing agents because of their ease of use, among other factors. Fluorocarbons not only act as blowing agents by virtue of their volatility, but also are encapsulated or entrained in the closed cell structure of the rigid foam and are generally the major contributor to the thermal conductivity properties of the rigid urethane foams. After the foam is formed, the k-factor associated with the foam produced provides a measure of the ability of the foam to resist the transfer of heat through the foam material. As the k-factor decreases, this is an indication that the material is more resistant to heat transfer and therefore a better foam for insulation purposes. Thus, materials that produce lower k-factor foams are generally desirable and advantageous.

In recent years, concern over climate change has driven the development of a new generation of fluorocarbons, which meet the requirements of both ozone depletion and climate change regulations. Two such fluorocarbons are trans-1,3,3,3-tetrafluoropropene (1234ze(E)) and trans-1-chloro-3,3,3-trifluoropropene (1233zd(E) or HBA-2). Both of these products incorporate the required environmental properties, while maintaining the anticipated high performance characteristics that have differentiated fluorocarbon blowing agents as a lead candidate for high performance rigid foam insulation applications.

### SUMMARY OF THE INVENTION

In one aspect, the present invention relates to foamable compositions (including in preferred embodiments thermosetting foam premix compositions), methods for applying a sprayable foam, and in preferred embodiments sprayable polyol foam, and to spray-applied foams, each formed from a thermosetting foaming agent/thermoset foam and a blowing agent, wherein the blowing agent comprises, preferably in major proportion by weight, trans-1-chloro-3,3,3-trifluoropropene (1233zd(E)). According to certain highly preferred embodiments, the compositions and methods produce foams having highly advantageous properties in connection with formation and/or application of the foam under conditions of relatively high humidity and/or relatively high temperature. For example, in certain of such highly preferred embodiments, the resulting foam according to the present invention possesses advantageous properties in terms of density consistency and/or thermal insulating properties, and each of these properties, and especially the combination of these two properties, is not only highly advantageous but thoroughly unexpected in view of the teachings of the prior art.

In certain preferred embodiments the methods comprised forming or providing a foamable composition (and preferably a polyol foamable composition) comprising a blowing agent of the present invention, spraying the foamable composition onto a substrate, including onto a surface or cavity of a building envelope; and curing the a polyol foam premix composition to form a closed cell foam having at least a portion of the blowing agent of the present invention in at least a plurality of the cells, preferably wherein at least one of said spraying step and said curing step is carried out at least in part, and preferably insubstantial part, under conditions of relatively high humidity and/or relatively high temperature. As used in the present application, the term “relatively high humidity” refers to ambient humidity conditions of greater than about 30 relative percent more preferably greater than about 40 relative percent and even more preferably greater than about 45 relative percent humidity, with relative humidity bbeen determined as described herein. As used in the present application, the term “relatively high temperature” refers to ambient temperatures of greater than about 26° C., more preferably greater than about 30° C., and even more preferably greater than about 32° C. With respect to temperature conditions, it is preferred in certain embodiments that the relatively high temperature is less than about 60° C., more preferably less than about 50° C., and even more preferably less than about 45° C.

According to certain preferred embodiments, within the resulting foam structure a majority of the cells contain a gas that includes trans-1-chloro-3,3,3-trifluoropropene. In certain aspects, the gas includes at least 50% by volume of said trans-1-chloro-3,3,3-trifluoropropene, and, in further aspects, the gas within the cells comprises at least about 70% by volume of said trans-1-chloro-3,3,3-trifluoropropene, and even further preferred embodiments consists essentially of trans-1-chloro-3,3,3-trifluoropropene.

In further preferred aspects, the foam exhibits less than 1.0% weight loss when tested using a Mobil 45° test, or less than 0.5% weight loss when tested using a Mobil 45° test. While the foregoing measures improved flammability using the Mobil 45° test, such a testing measure is not considered limiting to the invention. Preferred foams in accordance with the present invention will similarly exhibit substantially improved non-flammability in other standard tests known in the art. By way of non-limiting example, it will exhibit substantial improvement, particularly over foams prepared using 245fa, in other small scale testing, such as the B2. The resulting foam will also exhibit a significant reduction in flame height and will exhibit less flame spread when tested on full scale tests such as ASTM E-84, NFPA 286 and FM 4880. Accordingly, such foams demonstrate an overall reduction of flammability and decrease the need for certain additional agents, such as flame retardants.

In certain preferred aspects of the present invention, the foam formed in accordance with the present compositions and methods exhibits a density variance at relatively high temperatures, and even more preferably at about 33° C., of less than about 9, more preferably less than about 8, and more preferably in certain embodiments less than about 6. In certain embodiments, the density variance at relatively high temperatures is about five or less.

In certain aspects of the present invention, the foam formed in accordance with the present compositions and methods exhibits a lambda, as that value is hear in calculated, under relatively high temperature conditions that is at least about 5%, more preferably at least about 7%, and even more preferably at least about 10% better than the lambda produced using the same formulation except with HFC-245fa used in place of trans-1233zd in a blowing agent composition. In certain aspects, the lambda improvement under these conditions is about 15% or better.

In certain aspects of the present invention, the foam formed in accordance with the present compositions and methods exhibits a tack free time, as that value is here in calculated, under relatively high relative humidity conditions that is less than about 25 seconds, more preferably less than about 20 seconds, and even more preferably less than about 15 seconds. In certain highly preferred embodiments, the tax free time is about 12 seconds or less.

In certain aspects of the present invention, the foam formed in accordance with the present compositions and methods exhibits a lambda, as that value is hear in calculated, under relatively high relative humidity conditions that is at least about 5%, more preferably at least about 7%, and even more preferably at least about 10% better than the lambda produced using the same formulation except with HFC-245fa used in place of trans-1233zd in a blowing agent composition. In certain aspects, the lambda improvement under these conditions is about 15% or better.

In certain aspects of the polyol premix compositions herein, the polyol component may be present in an amount of from about 60 wt. % to about 95 wt. %, and trans-1-chloro-3,3,3-trifluoropropene is in an amount of from about 1 wt. % to about 30 wt. %.

The polyol premix may also include at least one additional blowing agent other than trans-1-chloro-3,3,3-trifluoropropene. Such additional blowing agents may be selected from one or a combination of water, organic acids that produce CO₂ and/or CO, hydrocarbons; ethers, halogenated ethers; esters, alcohols, aldehydes, ketones, pentafluorobutane; pentafluoropropane; hexafluoropropane; heptafluoropropane; trans-1,2 dichloroethylene; methylal, methyl formate; 1-chloro-1,2,2,2-tetrafluoroethane (HCFC-124); 1,1-dichloro-1-fluoroethane (HCFC-141b); 1,1,1,2-tetrafluoroethane (HFC-134a); 1,1,2,2-tetrafluoroethane (HFC-134); 1-chloro 1,1-difluoroethane (HCFC-142b); 1,1,1,3,3-pentafluorobutane (HFC-365mfc); 1,1,1,2,3,3,3-heptafluoropropane (HFC-227ea); trichlorofluoromethane (CFC-11); dichlorodifluoromethane (CFC-12); dichlorofluoromethane (HCFC-22); 1,1,1,3,3,3-hexafluoropropane (HFC-236fa); 1,1,1,2,3,3-hexafluoropropane (HFC-236e); 1,1,1,2,3,3,3-heptafluoropropane (HFC-227ea), difluoromethane (HFC-32); 1,1-difluoroethane (HFC-152a); 1,1,1,3,3-pentafluoropropane (HFC-245fa); 1,3,3,3-tetrafluoropropene (HFO-1234ze); 1,1,1,4,4,4-hexafluorobut-2-ene (HFO-1336mzzm); butane; isobutane; normal pentane; isopentane; or cyclopentane.

The polyol premix may also include one or more additional agents selected from a silicone surfactant, a non-silicone surfactant, a metal catalyst, an amine catalyst, a flame retardant, and combinations thereof. In embodiments where the silicone surfactant is provided, it may be present in an amount of from about 0.5 wt. % to about 5.0 wt. %. In embodiments where the non-silicone surfactant is provided, it may be present in an amount of from about 0.05 wt. % to about 3.0 wt. %. In embodiments where the amine catalyst is provided, it may be present in an amount of from about 0.05 wt. % to about 3.0 wt. %. In embodiments where the metal catalyst is provided, it may be present in an amount of from about 0.5 wt. % to about 10.0 wt. %.

Additional embodiments and advantages of the present invention will be readily apparent to one of skill in the art on the basis of the disclosure provided herein.

### DETAILED DESCRIPTION OF THE INVENTION

Applicants have come to recognize the existence of an unexpected and surprising advantage when 1233zd (preferably the trans form thereof, 1233zd(E)) is used as the blowing agent in polyurethane foam applications, particularly spray foam applications. One particular advantage provided herein is that the foams and articles formed therefrom have non-flammability quality that is significantly and unexpectedly improved, particularly over foams formed using other known HFC blowing agents.

As is known by those skilled in the art, polyurethane foam is used extensively as the core insulation material in several types of articles. Previously, some of the most commonly used blowing agents for polyurethane foams included HFC-245fa, HFC-134a and hydrocarbons. Such compounds are commonly used in the majority of the polyurethane foam markets in developing countries. As the low global warming potential initiative emerges in developed countries and the HCFC phase-out in developing countries approaches, there is an increasing worldwide need and desire for low global warming potential (LGWP) blowing agents.

Applicants illustrate herein that one advantage of the present invention is that the resulting foam product of 1233zd has improved characteristics of the foam, and surprisingly, resulted in a foam exhibiting significant reduction in flammability. Flammability is a critical part of many local, regional, and national building codes. As demonstrated in the data herein, 1233zd foams had substantially better burn properties, e.g. significantly better weight loss percentage after burning, than was seen with the 245fa foams. In particular, it is noted that less than 1.0% weight loss was observed during Mobil 45° flammability testing with foams having 1233zd as a blowing agent. In further embodiments, less than 0.5% weight loss was observed. This is indicative that 1233zd is a surprisingly less flammable material and that the resulting foam using 1233zd as a blowing agent will have a surprisingly reduced flammability. While the foregoing measures improved flammability using the Mobil 45° test, such a testing measure is not considered limiting to the invention. Foams prepared with 1233zd in accordance with the present invention will similarly exhibit substantially improved non-flammability in other standard tests known in the art. By way of non-limiting example, it will exhibit substantial improvement, particularly over foams prepared using 245fa, in other small scale testing, such as the B2. The resulting foam will also exhibit a significant reduction in flame height and will exhibit less flame spread when tested on full scale tests such as ASTM E-84, NFPA 286 and FM 4880. Accordingly, such foams demonstrate an overall reduction of flammability and decrease the need for certain additional agents, such as flame retardants.

Accordingly, the present invention relates to the use of 1233zd as a blowing agent in a polyol premix, particularly premixes useful as a spray foam, and/or the primary gas component of the resulting foam cell structure. 1233zd may be provided alone or as a blend with one or more additional blowing agents. A nonexclusive list of such co-blowing agents include, but are not limited to, water, organic acids that produce CO₂ and/or CO, hydrocarbons; ethers, halogenated ethers; esters, alcohols, aldehydes, ketones, pentafluorobutane; pentafluoropropane; hexafluoropropane; heptafluoropropane; trans-1,2 dichloroethylene; methylal, methyl formate; 1-chloro-1,2,2,2-tetrafluoroethane (HCFC-124); 1,1-dichloro-1-fluoroethane (HCFC-141b); 1,1,1,2-tetrafluoroethane (HFC-134a); 1,1,2,2-tetrafluoroethane (HFC-134); 1-chloro 1,1-difluoroethane (HCFC-142b); 1,1,1,3,3-pentafluorobutane (HFC-365mfc); 1,1,1,2,3,3,3-heptafluoropropane (HFC-227ea); trichlorofluoromethane (CFC-11); dichlorodifluoromethane (CFC-12); dichlorofluoromethane (HCFC-22); 1,1,1,3,3,3-hexafluoropropane (HFC-236fa); 1,1,1,2,3,3-hexafluoropropane (HFC-236e); 1,1,1,2,3,3,3-heptafluoropropane (HFC-227ea), difluoromethane (HFC-32); 1,1-difluoroethane (HFC-152a); 1,1,1,3,3-pentafluoropropane (HFC-245fa); 1,3,3,3-tetrafluoropropene (HFO-1234ze—including its trans or “E” isomer); 1,1,1,4,4,4-hexafluorobut-2-ene (HFO-1336mzzm—including its cis or “Z” isomer); butane; isobutane; normal pentane; isopentane; cyclopentane, or combinations thereof. The 1233zd component is usually present in the polyol premix composition in an amount of from about 1 wt. % to about 30 wt. %, preferably from about 3 wt. % to about 25 wt. %, and more preferably from about 5 wt. % to about 25 wt. %, by weight of the polyol premix composition. Such amounts result in a foam cell structure containing a gas that primarily is comprised of 1233zd.

When both 1233zd and one or more additional blowing agents are present, 1233zd may be present in the blowing agent component in an amount of from about 5 wt. % to about 99 wt. %, from about 10 wt. % to about 90 wt. %, or from about 25 wt. % to about 85 wt. %, by weight of the blowing agent component; and the optional blowing agent is usually present in the blowing agent component in an amount of from about 95 wt. % to about 1 wt. %, from about 90 wt. % to about 10 wt. %, or from about 15 wt. % to about 75 wt. %, by weight of the blowing agent component. The content of the gas in the resulting foam cell structure is dependent upon the component amounts of blowing agents used in the blend.

The polyol component, which may include mixtures of polyols, can be any polyol which reacts in a known fashion with an isocyanate in preparing a polyurethane or polyisocyanurate foam. Useful polyols comprise one or more of a sucrose containing polyol; phenol, a phenol formaldehyde containing polyol; a glucose containing polyol; a sorbitol containing polyol; a methylglucoside containing polyol; an aromatic polyester polyol; glycerol; ethylene glycol; diethylene glycol; propylene glycol; graft copolymers of polyether polyols with a vinyl polymer; a copolymer of a polyether polyol with a polyurea; one or more of (a) condensed with one or more of (b): (a) glycerine, ethylene glycol, diethylene glycol, trimethylolpropane, ethylene diamine, pentaerythritol, soy oil, lecithin, tall oil, palm oil, castor oil; (b) ethylene oxide, propylene oxide, a mixture of ethylene oxide and propylene oxide; or combinations thereof. The polyol component is preferably present in the polyol premix composition in an amount of from about 60 wt. % to about 95 wt. %, preferably from about 65 wt. % to about 95 wt. %, and more preferably from about 70 wt. % to about 90 wt. %, by weight of the polyol premix composition.

In certain embodiments, the polyol premix composition may also contain at least one silicone-containing surfactant. The silicone-containing surfactant is used to aid in the formation of foam from the mixture, as well as to control the size of the bubbles of the foam so that a foam of a desired cell structure is obtained. Preferably, a foam with small bubbles or cells therein of uniform size is desired since it has the most desirable physical properties such as compressive strength and thermal conductivity. Also, it is critical to have a foam with stable cells which do not collapse prior to forming or during foam rise.

Silicone surfactants for use in the preparation of polyurethane or polyisocyanurate foams are available under a number of trade names known to those skilled in this art. Such materials have been found to be applicable over a wide range of formulations allowing uniform cell formation and maximum gas entrapment to achieve very low density foam structures. The preferred silicone surfactant comprises a polysiloxane polyoxyalkylene block co-polymer. Some representative silicone surfactants useful for this invention are Momentive's L-5130, L-5180, L-5340, L-5440, L-6100, L-6900, L-6980 and L-6988; Air Products DC-193, DC-197, DC-5582 , and DC-5598; and B-8404, B-8407, B-8409 and B-8462 from Goldschmidt AG of Essen, Germany. Others are disclosed in U.S. Pat. Nos. 2,834,748; 2,917,480; 2,846,458 and 4,147,847, the contents of which are incorporated herein by reference. The silicone surfactant component is usually present in the polyol premix composition in an amount of from about 0.5 wt. % to about 5.0 wt. %, preferably from about 1.0 wt. % to about 4.0 wt. %, and more preferably from about 1.5 wt. % to about 3.0 wt. %, by weight of the polyol premix composition.

The polyol premix composition may optionally contain a non-silicone surfactant, such as a non-silicone, non-ionic surfactant. Such may include oxyethylated alkylphenols, oxyethylated fatty alcohols, paraffin oils, castor oil esters, ricinoleic acid esters, turkey red oil, groundnut oil, paraffins, and fatty alcohols. A preferred, but non-limiting, non-silicone non-ionic surfactant is LK-443 which is commercially available from Air Products Corporation. When a non-silicone, non-ionic surfactant used, it is present in the polyol premix composition in an amount of from about 0.05 wt. % to about 3.0 wt. %, preferably from about 0.05 wt. % to about 2.5 wt. %, and more preferably from about 0.1 wt. % to about 2.0 wt. %, by weight of the polyol premix composition.

The polyol premix composition may also include one or more catalysts, in particular amine catalysts and/or metal catalysts. Amine catalysts may include, but are not limited to, primary amine, secondary amine or tertiary amine. Useful tertiary amine catalysts non-exclusively include N,N,N′,N″,N″-pentamethyldiethyltriamine, N,N-dicyclohexylmethylamine; N,N-ethyldiisopropylamine; N,N-dimethylcyclohexylamine; N,N-dimethylisopropylamine; N-methyl-N-isopropylbenzylamine; N-methyl-N-cyclopentylbenzylamine; N-isopropyl-N-sec-butyl-trifluoroethylamine; N,N-diethyl-(α-phenylethyl)amine, N,N,N-tri-n-propylamine, or combinations thereof. Useful secondary amine catalysts non-exclusively include dicyclohexylamine; t-butylisopropylamine ; di-t-butylamine; cyclohexyl-t-butylamine; di-sec-butylamine, dicyclopentylamine; di-(α-trifluoromethylethyl)amine; di-(α-phenylethyl)amine; or combinations thereof.

Useful primary amine catalysts non-exclusively include: triphenylmethylamine and 1,1-diethyl-n-propylamine.

Other useful amines includes morpholines, imidazoles, ether containing compounds, and the like. These include
dimorpholinodiethylether
N-ethylmorpholine
N-methylmorpholine
bis(dimethylaminoethyl)ether
imidizole
n-methylimidazole
1,2-dimethylimidazole
dimorpholinodimethylether
N,N,N′,N′,N″,N″-pentamethyldiethylenetriamine
N,N,N′,N′,N″,N″-pentaethyldiethylenetriamine
N,N,N′,N′,N″,N″-pentamethyldipropylenetriamine
bis(diethylaminoethyl)ether
bis(dimethylaminopropyl)ether.

When an amine catalyst is used, it is present in the polyol premix composition in an amount of from about 0.05 wt. % to about 3.0 wt. %, preferably from about 0.05 wt. % to about 2.5 wt. %, and more preferably from about 0.1 wt. % to about 2.0 wt. %, by weight of the polyol premix composition.

Catalysts may also include one or a combination of metal catalysts, such as, but not limited to organometallic catalysts. The term organometallic catalyst refers to and is intended to cover in its broad sense both to preformed organometalic complexes and to compositions (including physical combinations, mixtures and/or blends) comprising metal carboxylates and/or amidines. In preferred embodiments, the catalyst of the present invention comprises: (a) one or more metal selected from the group consisting of zinc, lithium, sodium, magnesium, barium, potassium, calcium, bismuth, cadmium, aluminum, zirconium, tin, or hafnium, titanium, lanthanum, vanadium, niobium, tantalum, tellurium, molybdenum, tungsten, cesium; (b) in a complex and/or composition with an amidine compound; and/or (c) in a complex and/or composition with an aliphatic compound, aromatic compound and/or polymeric carboxylate.

Preferred among the amidine compounds for certain embodiments are those which contain catalytic amidine groups, particularly those having a heterocyclic ring (with the linking preferably being —N═C—N—), for example an imidazoline, imidazole, tetrahydropyrimidine, dihydropyrimidine or pyrimidine ring. Acyclic amidines and guanidines can alternatively be used. One preferred catalyst complex/composition comprises zinc (II), a methyl, ethyl, or propyl hexannoate, and a imidazole (preferably an lower alkylimidazole such as methylimidazole. Such catalysts may include Zn(1-methylimidazole)₂(2-ethylhexannoate)₂, together with, di-ethylene glycol, preferably as a solvent for the catalyst. To this end, one exemplified catalyst includes, but is not limited to, a catalyst sold under the trade designation K-Kat XK-614 by King Industries of Norwalk, Conn. Other catalysts include those sold under the trade designation Dabco K 15 and/or Dabco MB 20 by Air Products, Inc.

When one or a combination of metal catalysts are used, such a catalyst(s) is present in the polyol premix composition in an amount of from about 0.5 wt. % to about 10 wt. %, or preferably from about 1.0 wt. % to about 8.0 wt. % by weight of the polyol premix composition.

The preparation of polyurethane or polyisocyanurate foams using the compositions described herein may follow any of the methods well known in the art can be employed, see Saunders and Frisch, Volumes I and II Polyurethanes Chemistry and technology, 1962, John Wiley and Sons, New York, N.Y. or Gum, Reese, Ulrich, Reaction Polymers, 1992, Oxford University Press, New York, N.Y. or Klempner and Sendijarevic, Polymeric Foams and Foam Technology, 2004, Hanser Gardner Publications, Cincinnati, Ohio. In general, polyurethane or polyisocyanurate foams are prepared by combining an isocyanate, the polyol premix composition, and other materials such as optional flame retardants, water, colorants, or other additives. These foams can be rigid, flexible, or semi-rigid, and can have a closed cell structure, an open cell structure or a mixture of open and closed cells.

It is convenient in many applications to provide the components for polyurethane or polyisocyanurate foams in pre-blended formulations. Most typically, the foam formulation is pre-blended into two components. The isocyanate and optionally other isocyanate compatible raw materials, including but not limited to blowing agents and certain silicone surfactants, comprise the first component, commonly referred to as the “A” component. The polyol mixture composition, including surfactant, catalysts, blowing agents, and optional other ingredients comprise the second component, commonly referred to as the “B” component. In any given application, the “B” component may not contain all the above listed components, for example some formulations omit the flame retardant if flame retardancy is not a required foam property. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, water, and even other polyols can be added as a stream to the mix head or reaction site. Most conveniently, however, they are all, with the exception of water, incorporated into one B component as described above.

A foamable composition suitable for forming a polyurethane or polyisocyanurate foam may be formed by reacting an organic polyisocyanate and the polyol premix composition described above. Any organic polyisocyanate can be employed in polyurethane or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates which are well known in the field of polyurethane chemistry. These are described in, for example, U.S. Pat. Nos. 4,868,224; 3,401,190; 3,454,606; 3,277,138; 3,492,330; 3,001,973; 3,394,164; 3,124,605; and 3,201,372. Preferred as a class are the aromatic polyisocyanates.

Representative organic polyisocyanates correspond to the formula:

R(NCO)_{z}

wherein R is a polyvalent organic radical which is either aliphatic, aralkyl, aromatic or mixtures thereof, and z is an integer which corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate and the like; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5-′tetraisocyanate, and the like; arylalkyl polyisocyanates such as xylylene diisocyanate; aliphatic polyisocyanate such as hexamethylene-1,6-diisocyanate, lysine diisocyanate methylester and the like; and mixtures thereof. Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate; Typical aliphatic polyisocyanates are alkylene diisocyanates such as trimethylene diisocyanate, tetramethylene diisocyanate, and hexamethylene diisocyanate, isophorene diisocyanate, 4,4′-methylenebis(cyclohexyl isocyanate), and the like; typical aromatic polyisocyanates include m-, and p-phenylene disocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane, and the like. Preferred polyisocyanates are the polymethylene polyphenyl isocyanates, Particularly the mixtures containing from about 30 to about 85 percent by weight of methylenebis(phenyl isocyanate) with the remainder of the mixture comprising the polymethylene polyphenyl polyisocyanates of functionality higher than 2. These polyisocyanates are prepared by conventional methods known in the art. In the present invention, the polyisocyanate and the polyol are employed in amounts which will yield an NCO/OH stoichiometric ratio in a range of from about 0.9 to about 5.0. In the present invention, the NCO/OH equivalent ratio is, preferably, about 1.0 or more and about 3.0 or less, with the ideal range being from about 1.1 to about 2.5. Especially suitable organic polyisocyanate include polymethylene polyphenyl isocyanate, methylenebis(phenyl isocyanate), toluene diisocyanates, or combinations thereof.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art, including, but not limited to, glycine salts, tertiary amine trimerization catalysts, quaternary ammonium carboxylates, and alkali metal carboxylic acid salts and mixtures of the various types of catalysts. Preferred species within the classes are potassium acetate, potassium octoate, and N-(2-hydroxy-5-nonylphenol)methyl-N-methylglycinate.

Conventional flame retardants can also be incorporated, preferably in amount of not more than about 20 percent by weight of the reactants. Optional flame retardants include tris(2-chloroethyl)phosphate, tris(2-chloropropyl)phosphate, tris(2,3-dibromopropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl)aminomethylphosphonate, dimethyl methylphosphonate, tri(2,3-dibromopropyl)phosphate, tri(1,3-dichloropropyl)phosphate, and tetra-kis-(2-chloroethyl)ethylene diphosphate, triethylphosphate, diammonium phosphate, various halogenated aromatic compounds, antimony oxide, aluminum trihydrate, polyvinyl chloride, melamine, and the like. Other optional ingredients can include from 0 to about 7 percent water, which chemically reacts with the isocyanate to produce carbon dioxide. This carbon dioxide acts as an auxiliary blowing agent. In the case of this invention, the water cannot be added to the polyol blend but, if used, can be added as a separate chemical stream. Formic acid is also used to produce carbon dioxide by reacting with the isocyanate and is optionally added to the “B” component.

In addition to the previously described ingredients, other ingredients such as, dyes, fillers, pigments and the like can be included in the preparation of the foams. Dispersing agents and cell stabilizers can be incorporated into the present blends. Conventional fillers for use herein include, for example, aluminum silicate, calcium silicate, magnesium silicate, calcium carbonate, barium sulfate, calcium sulfate, glass fibers, carbon black and silica. The filler, if used, is normally present in an amount by weight ranging from about 5 parts to 100 parts per 100 parts of polyol. A pigment which can be used herein can be any conventional pigment such as titanium dioxide, zinc oxide, iron oxide, antimony oxide, chrome green, chrome yellow, iron blue siennas, molybdate oranges and organic pigments such as para reds, benzidine yellow, toluidine red, toners and phthalocyanines.

The polyurethane or polyisocyanurate foams produced can vary in density from about 0.5 pounds per cubic foot to about 60 pounds per cubic foot, preferably from about 1.0 to 20.0 pounds per cubic foot, and most preferably from about 1.5 to 6.0 pounds per cubic foot. The density obtained is a function of how much of the blowing agent or blowing agent mixture disclosed in this invention plus the amount of auxiliary blowing agent, such as water or other co-blowing agents is present in the A and/or B components, or alternatively added at the time the foam is prepared. These foams can be rigid, flexible, or semi-rigid foams, and can have a closed cell structure, an open cell structure or a mixture of open and closed cells. These foams are used in a variety of well known applications, including but not limited to thermal insulation, cushioning, flotation, packaging, adhesives, void filling, crafts and decorative, and shock absorption.

Among many uses, the foams of the present invention may be used to insulate buildings (e.g. building envelope) or any construction where energy management and/or insulation from temperature fluctuations on its exterior side are desirable. Such structures include any standard structure known in the art including, but not limited to those, manufactured from clay, wood, stone, metals, plastics, cement, or the like, including, but not limited to homes, office buildings, or other structures residential, commercial, or otherwise were energy efficiency and insulation may be desirable.

In one non-limiting aspect of the invention, a two part spray foam or foamable composition in accordance with the foregoing embodiments may be provided. The components of the A-side and the components of the B-side may be delivered through separate lines into a spray gun, such as an impingement-type spray gun. The gun is heated to a temperature above the boiling point of the blowing agent 1233zd, and the two components are pumped through small orifices at high pressure to form streams of the individual components of the A-side and the B-side. The streams of the first and second components intersect and mix with each other and heat up within the gun. Because the components are under pressure inside the gun, the blowing agent does not vaporize. However, as the mixture exits the gun and enters into atmospheric pressure, the blowing agent vaporizes as crosslinking of the polyol and polyurethane or polyisocyanurate occur. Crosslinking captures the bubbles generated by the evolution of the gas before they can coalesce and escape and forms cells that provide the insulative function.

Such foams, in certain embodiments, may be sprayed into the faces of studs, collar beams, and/or any closed or open wall cavity of a building envelope or structure discussed herein. In certain preferred embodiments, the foams of the present invention may be used to seal such insulative cavities of a building envelope such as a house, commercial building, or the like to eliminate air flow into the insulative cavities and effectively seal and insulate the envelope. Desirably, the foam is sprayed onto the stud faces, framing, cavities, etc. prior to the installation of building interior walls, though the foam may also be applied to such areas after the interior walls are erected using methods known in the art. In alternative embodiments, the foams of the present invention may serve as a sealant to air infiltration by filling cracks and/or crevices in a building's roof or walls, around doors, windows, electric boxes, and the like. The foam may also be applied to seal holes in walls and floors.

The following non-limiting examples serve to illustrate the invention.

### EXAMPLES

### Example 1

### Foam Formulation

The foam formulation used is a higher index formulation. It is a generic formulation that allows for comparison of blowing agents in the same formulation and is provided below in Table 1.

TABLE 1
Formulations

| Components | 245fa | HBA-2 |
|---|---|---|
| Mannich polyether polyol | 40.0 | 40.0 |
| (Voranol 470x) | | |
| Aromatic polyester polyol | 60.0 | 60.0 |
| (Terate 4020) | | |
| Silicone Surfactant (DC-193) | 2.0 | 2.0 |
| Amine catalysts (Polycat 12) | 2.0 | 2.0 |
| Metal catalysts (Dabco K 15 | 4.1 | 4.1 |
| (1.4), Dabco MB 20 (0.7), and | | |
| Kcat 614 (2.0)) | | |
| Flame retardant (Antiblaze 80) | 20.0 | 20.0 |
| Water | 2.0 | 2.0 |
| 245fa | 20.0 | — |
| HBA-2 | — | Equal molar |
| Index | 130 | 130 |

The foams were formed at 30° C. and at a humidity of 30%. To simulate the building environment, the systems were sprayed onto 122 cm×244 cm×1.25 cm sheets of plywood, a common building material. The plywood surface absorbs humidity and is more difficult to cover because of its irregular surface. The plywood was stored in the environmental test chamber and allowed to come to temperature prior to being used. The temperature of the substrate was confirmed with a handheld thermometer prior to beginning each test.

Spray foam processing equipment is conceptually very simple. It consists of 4 major components: drum pumps, proportioning unit, heated transfer hoses and a spray gun. The drum pump, proportioning unit and the hoses are fairly consistent in the industry in what is offered and how they operate. The equipment and processing parameters used in this study are listed in Table 2. To insure consistency in application the foam was applied robotically using the West Development Group Robotics.

TABLE 2
Equipment and Processing Parameters
Equipment

| Proportioner: | Graco Reactor H40 |
|---|---|
| Spray Gun: | Probler P2 utilizing #2 tip |
| | and chamber |
| Hose length, m: | 30.5 |
| Hose temperature, ° C.: | 49-53 |

Processing Conditions
Polyol

| | |
|---|---|
| Temperature, ° C.: | 47-52 |
| Pressure, Bar: Static/Dynamic: | 10.3-11.7/8.3-9.0 |

PMDI

| | |
|---|---|
| Temperature, ° C.: | 49-52 |
| Pressure, Bar: Static/Dynamic: | 9.0-11.7/10.3-11.7 |

### Example 2

### Flammability Study

Foams were prepared in accordance with Example 1. They were tested for flammability via the Mobil 45° test. More specifically, at least 3 test specimens measuring 5.1 cm×21.6 cm×1.3 cm (2″×8.5″×½″) with the foam rise parallel to the 1.3 cm (½″) dimension were provided. Each sample was weighed to the nearest 0.01 gram (0.0004 oz) and recorded as W₀.

Each sample was placed above a micro burner at approximately a 45° angle such that the sample was approximately 1.3 cm (½″) above the burner top. The burner was turned on and the flame set to a height of 3.8 cm (1.5″) and adjusted so that the flame spread evenly along the two surfaces parallel to the flame and the two surfaces forming 45° angles. The burner was left under the sample until all visible flaming ceased on the foam sample. Each charred sample was then weighed to nearest 0.01 g (0.0004 oz) and recorded as W₁.

The percent loss was calculated as follows:

% Weigh Loss=(W₀−W₁)/W₀)×100 and recorded

These steps were performed on all three separate samples and the results were averaged and are provided below in Table 3. Both 245fa and 1233zd(E) are non flammable blowing agents. The fluorocarbon materials are physical blowing agents meaning that they are volatilized during the foam reaction due to the exothermic nature of the reaction. These materials are not physically changed during the foam manufacturing process. There was no detection of decomposition of the blowing agent in the cell gas of the foam. It is unanticipated that there would be a significant difference in the flammability of the foam. Therefore it was surprising that the results in Table 3 were found, namely that 1233zd foams had substantially better burn properties in this test than seen with the 245fa foams.

TABLE 3
Mobil 45° Test Results

| Blowing Agent | 245fa | 1233zd |
|---|---|---|
| Application Temperature, C. | 33 | 33 |
| Application Humidity, % RH | 52 | 52 |
| % Weight Loss | 1.25 | 0.26 |

### Example 3

### Foam Formulation

Foams are prepared in accordance with Example 1. They are tested for flammability via ASTM E-84.

Each sample is placed in the E-84 tunnel. The burner is turned on and the flame set to prescribed height in the ASTM procedure. The flame spread is measured. When compared the flame spread for the 245fa foam is expected to be less than that for the 1233zd foam.

Both 245fa and 1233zd(E) are non flammable blowing agents. The fluorocarbon materials are physical blowing agents meaning that they are volatilized during the foam reaction due to the exothermic nature of the reaction. These materials are not decomposed during the foam manufacturing process. It is unanticipated that there would be a significant difference in the flammability of the foam.

### Example 4

### Application to a Building Envelope

Two sample foam A-side and B-side premixes are prepared using the ingredients and amounts provided in Example 1 and Table 1, above, with one having 1233zd as a blowing agent and the other having HFC-245fa. The A-side portion includes isocyanate component and the B-side portion includes the polyol mixture surfactant, catalysts, flame retardants and blowing agents (1233zd(E) or HFC-245fa). Using the equipment and methods provided in Example 1 and Table 2, the A and B side components the 1233zd premix and HFC-245fa premix are independently brought together and sprayed into frame structure of a building envelope, a structure having studs and an exterior wall made of plywood, and are allowed to cure. The foam is formed at 30° C. and at a humidity of 30%.

The two foams are tested for flammability via the Mobil 45° test. More specifically, at least 3 test specimens measuring 5.1 cm×21.6 cm×1.3 cm (2″×8.5″×½″) with the foam rise parallel to the 1.3 cm (½″) dimension are provided. Each sample is weighed to the nearest 0.01 gram (0.0004 oz) and recorded as W₀.

Each sample is placed above a micro burner at approximately a 45° angle such that the sample is approximately 1.3 cm (½″) above the burner top. The burner is turned on and the flame set to a height of 3.8 cm (1.5″) and adjusted so that the flame spreads evenly along the two surfaces parallel to the flame and the two surfaces forming 45° angles. The burner is left under the sample until all visible flaming ceased on the foam sample. Each charred sample is then weighed to nearest 0.01 g (0.0004 oz) and recorded as W₁.

The percent loss is calculated as follows:

% Weigh Loss=(W₀−W₁)/W₀)×100 and recorded

These steps are performed on all three separate samples and the results averaged. Consistent with the results above, it is surprising that the 1233zd foams have substantially better burn properties in this test than seen with the 245fa foams.

### Example 4 and Comparative Example 4C

Using the same foam formulation and equipment as described in Example 1 above, spray applied foams were formed using a blowing agent according to the present invention (consisting of trans-1233zd) and for comparative purposes consisting of HFC-245fa. The results of these tests are reported in the following Tables 4- and 5.

TABLE 4
Foam Reactivity

| | Room Temperature During Spraying | | | | | |
|---|---|---|---|---|---|---|
| | | 245fa | | | 1233zd(E) | |
| | 17° C. | 26° C. | 33° C. | 17° C. | 26° C. | 33° C. |
| Cream | Imme- | Imme- | Imme- | Imme- | Imme- | Imme- |
| | diate | diate | diate | diate | diate | diate |
| Gel | 5 | 5 | 5 | 8 | 8 | 8 |
| Tack Free | 23 | 20 | 28 | 23 | 22 | 22 |

TABLE 5
Comparison of Foam Density with Different Application Temperatures

| | 17° C. | | 26° C. | | 33° C. | |
|---|---|---|---|---|---|---|
| | 245fa | 1233zd(E) | 245fa | 1233zd(E) | 245fa | 1233zd(E) |
| Immersion | 38 | 39 | 38 | 40 | 38 | 39 |
| Density, with | | | | | | |
| skin, kg/m^{3A} | | | | | | |
| Dry Density, | 33 | 32 | 33 | 33 | 29 | 34 |
| without skin, | | | | | | |
| kg/m³ | | | | | | |
| Variance | 6 | 7 | 5 | 7 | 9 | 5 |

TABLE 6
Impact of Application Temperatures on lambda

| Comparison of | | | |
|---|---|---|---|
| 1233zd(E)1233zd(E) | Application Room Temperature | | |
| vs 245fa | 16° C. | 26° C. | 33° C. |

Initial lambda

| | | | |
|---|---|---|---|
| 245fa | 23.85 | 23.14 | 23.85 |
| 1233zd(E)1233zd(E) | 21.54 | 21.47 | 21.54 |
| Conclusion | LBA is | LBA is | LBA is |
| | 10% better | 7% better | 10% better |

Aged lambda

| | | | |
|---|---|---|---|
| 245fa | 31.29 | 27.72 | 31.29 |
| 1233zd(E)1233zd(E) | 26.48 | 25.97 | 26.48 |
| Conclusion | LBA is | LBA is | LBA is |
| | 15% better | 7% better | 15% better |

TABLE 7
Comparison of Foam Density and Foam
Density with Different Humidities

| | 245fa | | 1233zd(E)1233zd(E) | |
|---|---|---|---|---|
| | 33% RH | 52% RH | 33% RH | 52% RH |
| Cream Time, sec | Immediate | Immediate | Immediate | Immediate |
| Gel Time, sec | 5 | 5 | 8 | 5 |
| Tack Free | 28 | 12 | 28 | 12 |
| Time, sec | | | | |
| Dry Core | 29.3 | 40.2 | 33.8 | 31.8 |
| Density, kg/m³ | | | | |

TABLE 8
Comparison of Foam Density and Foam
Density with Different Humidities

| | 245fa | | 1233zd(E)1233zd(E) | |
|---|---|---|---|---|
| | 33% RH | 52% RH | 33% RH | 52% RH |
| Cream Time, sec | Immediate | Immediate | Immediate | Immediate |
| Gel Time, sec | 5 | 5 | 8 | 5 |
| Tack Free | 28 | 12 | 28 | 12 |
| Time, sec | | | | |
| Dry Core | 29.3 | 40.2 | 33.8 | 31.8 |
| Density, kg/m³ | | | | |

What is claimed is:

1. A method for applying a sprayable polyol foam to a substrate comprising:
providing a sprayable polyol foam premix composition comprising trans-1-chloro-3,3,3-trifluoropropene (1233zd(E)) as a blowing agent;
spraying the polyol foam premix composition under conditions of relatively high temperature and/or relatively high temperature onto said substrate; and
curing the a polyol foam premix composition to form a closed cell foam under conditions of relatively high temperature and/or relatively high temperature onto said substrate.

2. The method of claim 1, wherein the closed cell foam exhibits an at least about 5% lambda improvement compared to the same formulation, spray step and curing cure step except that HFC-245fa is in place of trasn-1233zd on a mole per mole basis.

3. The method of claim 1, wherein the applied foam exhibits a tack free time that is less than about 25 seconds.

4. The method of claim 1, wherein the applied foam exhibits a density variance of less than about 9.

5. The method of claim 1, wherein said gas comprises at least 50% by volume of said trans-1-chloro-3,3,3-trifluoropropene.

6. The method of claim 1, wherein said gas consists essentially of trans-1-chloro-3,3,3-trifluoropropene.

7. The method of claim 1, wherein polyurethane or polyisocyanurate foamable premix composition further comprises a polyol component, wherein the polyol component is present in an amount of from about 60 wt. % to about 95 wt. % and wherein trans-1-chloro-3,3,3-trifluoropropene is in an amount of from about 1 wt. % to about 30 wt. %.

8. The method of claim 7, further comprising at least one additional blowing agent other than trans-1-chloro-3,3,3-trifluoropropene, which is selected from the group consisting of water, organic acids that produce CO₂ and/or CO, hydrocarbons; ethers, halogenated ethers; esters, alcohols, aldehydes, ketones, pentafluorobutane; pentafluoropropane; hexafluoropropane; heptafluoropropane; trans-1,2 dichloroethylene; methylal, methyl formate; 1-chloro-1,2,2,2-tetrafluoroethane (HCFC-124); 1,1-dichloro-1-fluoroethane (HCFC-141b); 1,1,1,2-tetrafluoroethane (HFC-134a); 1,1,2,2-tetrafluoroethane (HFC-134); 1-chloro 1,1-difluoroethane (HCFC-142b); 1,1,1,3,3-pentafluorobutane (HFC-365mfc); 1,1,1,2,3,3,3-heptafluoropropane (HFC-227ea); trichlorofluoromethane (CFC-11); dichlorodifluoromethane (CFC-12); dichlorofluoromethane (HCFC-22); 1,1,1,3,3,3-hexafluoropropane (HFC-236fa); 1,1,1,2,3,3-hexafluoropropane (HFC-236e); 1,1,1,2,3,3,3-heptafluoropropane (HFC-227ea), difluoromethane (HFC-32); 1,1-difluoroethane (HFC-152a); 1,1,1,3,3-pentafluoropropane (HFC-245fa); 1,3,3,3-tetrafluoropropene (HFO-1234ze); 1,1,1,4,4,4-hexafluorobut-2-ene (HFO-1336mzzm); butane; isobutane; normal pentane; isopentane; cyclopentane, and combinations thereof.

9. The method of claim 7, further comprising one or more additional agents selected from the group consisting of a silicone surfactant, a non-silicone surfactant, a metal catalyst, an amine catalyst, a flame retardant, and combinations thereof.

10. The method of claim 9, wherein the silicone surfactant is provided in the polyol premix composition in an amount of from about 0.5 wt. % to about 5.0 wt. %.

11. The method of claim 9, wherein the non-silicone surfactant is provided in the polyol premix composition in an amount of from about 0.05 wt. % to about 3.0 wt. %.

12. The method of claim 9, wherein the amine catalyst is provided in the polyol premix composition in an amount of from about 0.05 wt. % to about 3.0 wt. %.

13. The method of claim 9, wherein the metal catalyst is provided in the polyol premix composition in an amount of from about 0.5 wt. % to about 10.0 wt. %.
